(19) United States
(12) Patent Application Publication
(10) Pub. No.: US 2026/0033566 A1
(43) Pub. Date: Feb. 5, 2026

(54) MULTI-CHANNEL TEMPERATURE CONTROL HEATING DEVICE AND WEARABLE HEATING PRODUCT THEREOF

(71) Applicant: KADENA INDUSTRIES LIMITED, HONG KONG (CN)

(72) Inventor: ZHUANG MA, HONG KONG (CN)

(21) Appl. No.: 19/005,313

(22) Filed: Dec. 30, 2024

Related U.S. Application Data
(63) Continuation of application No. PCT/CN2024/136623, filed on Dec. 4, 2024.

(30) Foreign Application Priority Data
Jul. 30, 2024 (CN) 202421819858.6

(51) Int. Cl. A41D 13/005; H05B 1/02; H05B 3/34

(52) U.S. Cl. CPC A41D 13/0051; H05B 1/0272; H05B 3/342

(57) ABSTRACT

The present disclosure provides a multi-channel temperature control heating device and a wearable heating product thereof. The multi-channel temperature control heating device includes a heating member including a plurality of heating pieces respectively set in different areas of the wearable heating product, and a control member including a main control unit connected to the plurality of heating pieces, and a plurality of temperature control switches connected to the main control unit, each of the plurality of temperature control switches configured to independently control a temperature of one of the plurality of heating pieces. The present disclosure can be convenient for independently and easily controlling temperatures of the plurality of heating pieces, with an easy and simple operation, thereby avoiding defects of inability to control temperatures in different parts thereof.

### BACKGROUND

### 1. Technical Field

The present disclosure generally relates to the technical field of heating and keeping warm clothing technologies, and especially relates to a multi-channel temperature control heating device and a wearable heating product thereof.

### 2. Description of Related Art

In a cold winter, it is important for one's physical health to keep warm during outdoor activities such as an outdoor work, a leisure, a fishing and watching sports games. However, thick clothes that are worn can cause inconvenience. In this way, wearable heating products that are lightweight and generating heat and keeping warm such as clothes and trousers are gradually gaining popularity in the market. A wearable heating product such as a thermal insulation clothing, generally corresponding to different areas of the human body such as a chest, an abdomen and a back etc., is equipped with a plurality of heating elements to increase a heating area and improve a warm effect thereof.

Due to different levels of sensitivity to temperatures, some people feel hot to a temperature while others feel just right for the same temperature; or the sensitivity that different body parts of the same person is to temperatures can vary. For example, for the same temperature, the chest and the abdomen can feel just right, but the back can feel a bit hot. Therefore, it is necessary that temperatures of the heating elements that are arranged on the wearable heating product can be adjustable so as to adapt to different requirements of body parts.

However, a temperature control of the conventional heating elements of the wearable heating product generally adopts two modes. One mode is a constant temperature mode that the temperature of the heating element can't be adjusted, and all heating elements have the same temperature, which can't meet different sensing requirements of different human for temperatures. The other mode is a manual adjustment mode which is to adjust the temperature of the heating element, but in the related art, the manual adjustment mode uniformly adjusts the temperatures of all heating elements of the wearable heating product. That is, if it is manually adjusted to 50 degrees, all temperatures of all heating elements of the wearable heating product will be 50 degrees. If it is manually adjusted to 40 degrees, the temperatures of all heating elements of the wearable heating product will be 40 degrees, which can't meet different temperature requirements of different body parts of the same person.

Therefore, the related art needs to be improved.

### SUMMARY

The technical problems to be solved: in view of the shortcomings of the related art, the present disclosure provides a multi-channel temperature control heating device for a wearable heating product which can be convenient for independently and easily controlling temperatures of the plurality of heating pieces thereof.

To achieve the above objectives, in a first aspect, the technical solution adopted for solving technical problems of the present disclosure is: a multi-channel temperature control heating device according to an embodiment of the present disclosure includes a heating member and a control member, wherein
the heating member includes a plurality of heating pieces respectively set in different areas of the wearable heating product; and
the control member includes a main control unit connected to the plurality of heating pieces, and a plurality of temperature control switches connected to the main control unit, each of the plurality of temperature control switches configured to independently control a temperature of one of the plurality of heating pieces.

Wherein the control member includes a controller arranged on the wearable heating product and including a housing configured to receive the main control unit therein, the plurality of temperature control switches arranged on the housing.

Wherein the controller further includes a plurality of gear status LED lamps arranged on the housing and respectively connected to the main control unit, each of the plurality of temperature control switches having different temperature gears to adjust a corresponding heating piece to have different temperatures, each of the plurality of gear status LED lamps associated with a corresponding temperature control switch, and each of the plurality of gear status LED lamps configured to display different colors to correspond to different temperature gears of the corresponding temperature control switch.

Wherein the control member further includes a plurality of temperature sensors, each of the plurality of temperature sensors closely attached to a corresponding heating piece and configured to collect temperature information of the corresponding heating piece and then send to the main control unit.

Wherein the main control unit further includes a master chip, a drive circuit connected to the master chip, and a temperature signal processing circuit connected to the master chip, wherein
the drive circuit is connected to the plurality of heating pieces, and the temperature signal processing circuit is connected to the plurality of temperature sensors.

Wherein the plurality of heating pieces at least includes a first heating piece, a second heating piece and a third heating piece; and wherein
the master chip is equipped with a first PWM output terminal, a second PWM output terminal, a third PWM output terminal and a current sampling terminal; and wherein
the drive circuit includes:
a first current limiting resistor, a second current limiting resistor and a third current limiting resistor;
a first bias resistor, a second bias resistor and a third bias resistor;
a first MOS transistor, a second MOS transistor, a third MOS transistor and sampling resistor; and wherein
a first end of the first current limiting resistor is connected to the first PWM output terminal, and a second end of the first current limiting resistor is connected to a gate of the first MOS transistor, a first end of the first bias resistor connected to the gate of the first MOS transistor, a second end of the first bias resistor grounded, a drain of the first MOS transistor connected to the first heating piece, and a source of the first MOS transistor connected to a first end of the sampling resistor; and wherein
a first end of the second current limiting resistor is connected to the second PWM output terminal, and a second end of the second current limiting resistor is connected to a gate of the second MOS transistor, a first end of the second bias resistor connected to the gate of the second MOS transistor, a second end of the second bias resistor grounded, a drain of the second MOS transistor connected to the second heating piece, and a source of the second MOS transistor connected to the first end of the sampling resistor; and wherein
a first end of the third current limiting resistor is connected to the third PWM output terminal, and a second end of the third current limiting resistor is connected to a gate of the third MOS transistor, a first end of the third bias resistor connected to the gate of the third MOS transistor, a second end of the third bias resistor grounded, a drain of the third MOS transistor connected to the third heating piece, and a source of the third MOS transistor connected to the first end of the sampling resistor; and wherein
a second end of the sampling resistor is grounded, and the first end of the sampling resistor is also connected to the current sampling terminal.

Wherein a first filtering resistor is connected in series between the first end of the sampling resistor and the current sampling terminal, and a first filtering capacitor is also connected in parallel between the first end of the sampling resistor and the current sampling terminal.

Wherein the master chip is also equipped with a plurality of temperature detection terminals, and the temperature signal processing circuit comprises a plurality of temperature signal processing units, each of the plurality of temperature signal processing units connected to a corresponding temperature detection terminal and a corresponding temperature sensor, one of the plurality of temperature signal processing units comprising a fourth current limiting resistor, a second filtering resistor and a second filtering capacitor; and wherein
a first end of the fourth current limiting resistor is connected to a power supply terminal, a second end of the fourth current limiting resistor is connected to a first end of a corresponding temperature sensor, and a second end of the corresponding temperature sensor is grounded, the first end of the corresponding temperature sensor also connected to a first end of the second filtering resistor, a second end of the second filtering resistor connected to the temperature detection terminal, and the second end of the second filtering resistor also connected to a first end of the second filtering capacitor, and a second end of the second filtering capacitor grounded.

Wherein the main control unit further includes a Bluetooth module connected to the master chip or integrated with the master chip, the Bluetooth module configured to enable a smartphone to connect to the multi-channel temperature control heating device through an APP, so as to control the plurality of heating pieces to be turned on/turned off and adjust temperatures of the plurality of heating pieces.

Wherein the main control unit further includes a voice module connected to the master chip and configured to collect voice commands to control the plurality of heating pieces to be turned on/turned off and adjust temperatures of the plurality of heating pieces.

Wherein each of the plurality of heating pieces includes a heating body, an insulation layer, a heat preservation layer and a heat-reflecting layer that are sequentially layered in sequence, the heating body connected to the main control unit, and all the heating body, the insulation layer, the heat preservation layer and the heat-reflecting layer sewed together as a whole.

Wherein the heating body is a heating wire or a flexible and bendable heating film.

Wherein the heating film is a PI (polyimide film) heating film.

Wherein the heat-reflecting layer is a metal reflection film.

Wherein the multi-channel temperature control heating device further includes a power supply member comprising a battery with a charge-discharge interface thereof, and the control member further comprises a power plug and an electricity detection circuit, wherein
the power plug is connected to the main control unit, and plug and unplug connected to the charge-discharge interface, and the electricity detection circuit is connected to both the power plug and the main control unit.

In a second aspect, a wearable heating product according to an embodiment of the present disclosure is equipped with the above mentioned multi-channel temperature control heating device used for the wearable heating product.

Wherein the wearable heating product is selected from one kind of a dress, a trouser, a hat, a belt and a scarf.

Wherein when the wearable heating product is a dress, the dress is equipped with at least three heating zones, and the multi-channel temperature control heating device is equipped with at least six heating pieces and three temperature control switches, one of the at least three heating zones equipped with two heating pieces, and one of the thee temperature control switches configured to simultaneously control temperatures of the two heating pieces.

It should be understood that within the scope of the present disclosure, the above-mentioned technical features of the present disclosure and specific technical features described in the following (such as embodiments) can be combined with each other to form new or preferred technical solutions, which will not be repeated here due to space limitations thereof.

The present disclosure provides the advantages as below.

Firstly, the multi-channel temperature control heating device of the present disclosure is provided that temperatures of the plurality of heating pieces can be adjusted to meet different temperature requirements of human bodies.

Secondly, the temperatures of the plurality of heating pieces can be independently adjusted to meet different temperature requirements of different parts of human bodies.

Thirdly, the plurality of heating pieces is designed with a multi-layer structure and uses materials with different functions to improve a warm effect, reduce heat loss and improve heat utilization efficiency thereof.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. Obviously, the drawings described below are some embodiments of the present disclosure, for one of ordinary skill in the related art, other drawings can be obtained according to the drawings below on the premise of no creative work.

FIG. 1 is a schematic diagram of a multi-channel temperature control heating device used for a wearable heating product in accordance with a first embodiment of the present disclosure.

FIG. 2 is a block diagram of the multi-channel temperature control heating device of FIG. 1.

FIG. 3 is a schematic view of the multi-channel temperature control heating device of FIG. 1, which is shown the multi-channel temperature control heating device used in a first wearable heating product.

FIG. 4 is similar to FIG. 3, but shown from a back view.

FIG. 5 is a schematic view of a controller of the multi-channel temperature control heating device of FIG. 1.

FIG. 6 is a schematic circuit view of a master chip of the multi-channel temperature control heating device of FIG. 1.

FIG. 7 is a schematic circuit view of a drive circuit of the multi-channel temperature control heating device of FIG. 1.

FIG. 8 is a schematic circuit view of a temperature signal processing unit of the multi-channel temperature control heating device of FIG. 1.

FIG. 9 is a schematic view of a heating piece of the multi-channel temperature control heating device of FIG. 1.

FIG. 10 is an exploded, schematic circuit view of the heating piece of FIG. 9.

FIG. 11 is a schematic view of a controller of the multi-channel temperature control heating device in accordance with a second embodiment of the present disclosure.

FIG. 12 is a schematic diagram of a multi-channel temperature control heating device in accordance with a third embodiment of the present disclosure.

FIG. 13 is a schematic diagram of a multi-channel temperature control heating device in accordance with a fourth embodiment of the present disclosure.

The element labels according to the exemplary embodiment of the present disclosure shown as below:
100 multi-channel temperature control heating device, 10 heating member, 11 heating piece, 111 first heating piece, 112 second heating piece, 113 third heating piece, 101 heating body, 102 insulation layer, 103 heat preservation layer, 104 heat-reflecting layer, 105 wire, 20 control member, 21 main control unit, 211 master chip, 212 drive circuit, 213 temperature signal processing circuit, 2130 temperature signal processing unit, 214 Bluetooth module, 215 voice module, 22 temperature control switch, 23 controller, 231 housing, 24 gear status LED lamp, 25 temperature sensor, 26 power plug, 27 electricity detection circuit, 30 power supply member, 31 battery, 32 charge-discharge interface, 40 USB charging cable, 41 first PWM output terminal, 42 second PWM output terminal, 43 third PWM output terminal, 44 current sampling terminal, 45 temperature detection terminal, 51 first current limiting resistor, 511 first end of first current limiting resistor, 512 second end of first current limiting resistor, 52 second current limiting resistor, 521 first end of second current limiting resistor, 522 second end of second current limiting resistor, 53 third current limiting resistor, 531 first end of third current limiting resistor, 532 second end of third current limiting resistor, 54 fourth current limiting resistor, 541 first end of fourth current limiting resistor, 542 second end of fourth current limiting resistor, 61 first bias resistor, 611 first end of first bias resistor, 612 second end of first bias resistor, 62 second bias resistor, 621 first end of second bias resistor, 622 second end of second bias resistor, 63 third bias resistor, 631 first end of third bias resistor, 632 second end of third bias resistor, 71 first MOS transistor, G gate, D drain, S source, 72 second MOS transistor, 73 third MOS transistor, 74 sampling resistor, 741 first end of sampling resistor, 742 second end of sampling resistor, 81 first filtering resistor, 811 first end of first filtering resistor, 812 second end of first filtering resistor, 82 first filtering capacitor, 83 second filtering resistor, 831 first end of second filtering resistor, 832 second end of second filtering resistor, 84 second filtering capacitor, 841 first end of second filtering capacitor, 842 second end of second filtering capacitor, 90 power supply terminal, 200 wearable heating product, 201 heating zone.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples. According to the described embodiment of the present disclosure, all other embodiments obtained by one of ordinary skill in the related art on the premise of no creative work are within the protection scope of the present disclosure.

In the description of the present disclosure, it needs to be explained that all the directional indicators (such as the terms: “upper”, “below”, “left”, “right”, “front”, “back” . . . ), are shown in the specification of the present disclosure. The indicated orientation or position of the terms shown in the detailed description is based on the orientation or position shown in the figures of the accompanying drawings of the present disclosure, which is only to easily simplify the description of the present disclosure, but not indicated that the devices or elements of the present disclosure should have a particular orientation or should be designed and operated in a particular orientation. So the terms illustrated in the detail description are not by way of the limitation of the present disclosure.

In the description of the present disclosure, except where specifically otherwise illustrated or limited, the terms “connect” and “link” used herein should be understood in a broad sense. Such as, the meaning may be tight connection, removable connection, or integrated connection. The meaning may also be mechanical connection, electrical connection, direct connection or indirect connection through intermediaries, or internal connection within two elements. The meaning of the terms used herein may be understood by one of ordinary skill in the related art according to specific conditions of the present disclosure.

Furthermore, in the description of the present disclosure, the terms such as “first” and “second” shown in the specification are only used to describe, but not indicated that the elements of the present disclosure is important or represented the amount of the elements. That is, the features limited by the terms of “first” and “second” may explicitly or implicitly include one or more features.

Specific implementation embodiments of the present disclosure are as follows, a first embodiment is shown below.

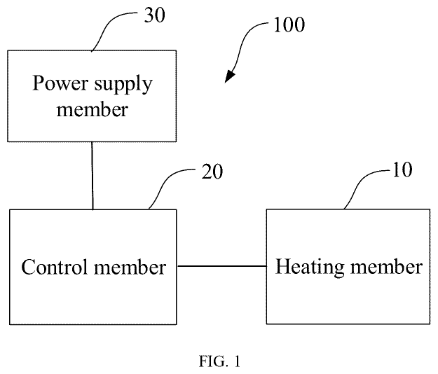

Referring to FIG. 1 to FIG. 10, a multi-channel temperature control heating device 100 used for a wearable heating product according to the first embodiment of the present disclosure includes a heating member 10, a control member 20 and a power supply member 30. The power supply member 30 is connected to the control member 20, and the control member 20 is connected to the heating member 10. The power supply member 30 supplies power to the control member 20 and the heating member 10, while the control member 20 is configured to turn on and turn off the heating member 10 and control a temperature of the heating member 10. The power supply member 30 can be an external power source or a battery, and the external power source can be input of a DC5V power. The control member 20 is equipped with a control chip and a control circuit, while the heating member 10 can be a component such as a heating wire and a heating element that can convert electrical energy into thermal energy.

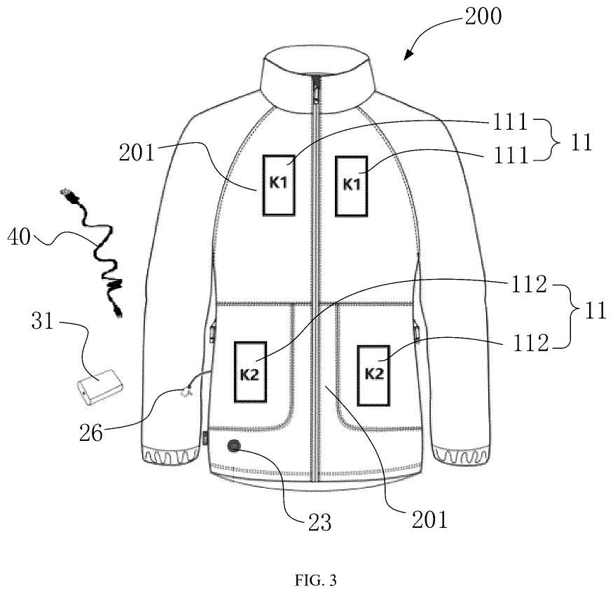

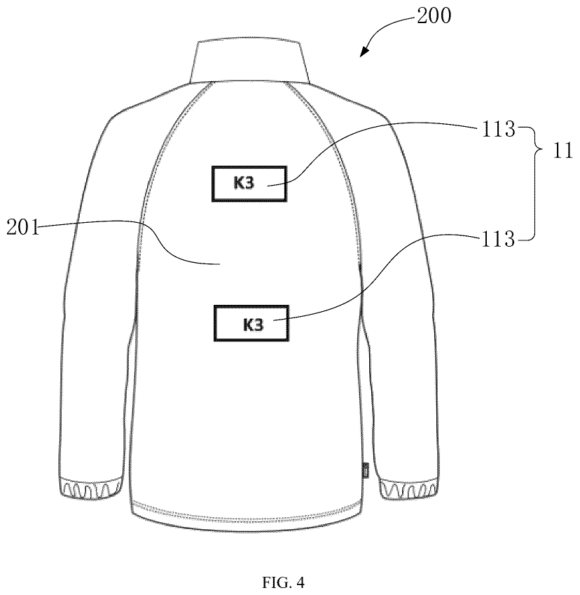

Specifically, the heating member 10 includes a plurality of heating pieces 11 respectively set in different areas of the wearable heating product 200. As shown in FIG. 3 and FIG. 4, as the first embodiment, the wearable heating product 200 of the present disclosure is a heating clothing divided into three different heating zones that are a chest zone, an abdomen zone and a back zone. Each heating zone is equipped with the heating piece 11, as shown in FIG. 3 and FIG. 4. The chest zone of the heating clothing is equipped with two first heating pieces 111 (that is the label K1 shown in FIG. 3), the abdomen zone of the heating clothing is equipped with two second heating pieces 112 (that is the label K2 shown in FIG. 3), and the back zone of the heating clothing is equipped with two third heating pieces 113 (that is the label K3 shown in FIG. 4). In this way, each of the chest zone, the abdomen zone and the back zone of the heating clothing can generate heat through their respective heating pieces 11 to keep the human body warm. It can be understood that in other embodiments of the present disclosure, the heating clothing can be divided into more heating zones, each heating zone is equipped with the heating pieces 11, and different numbers of heating pieces 11 can also be set in each heating zone of the heating clothing, such as one, two or three etc.

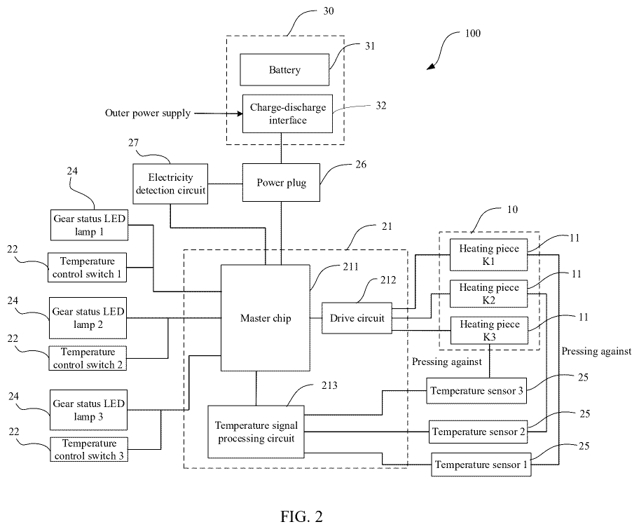

Referring to FIG. 2, the control member 20 includes a main control unit 21 connected to the plurality of heating pieces 11, and a plurality of temperature control switches 22 connected to the main control unit 21, each of the plurality of temperature control switches 22 configured to independently control a temperature of one of the plurality of heating pieces 11. That is, each temperature control switch 22 controls a corresponding heating piece 11, and the temperature control switch 22 sends a temperature control command to the main control unit 21, and then the main control unit 21 recognizes that the command is sent by which one of the plurality of temperature control switches 22 according to an input interface, and then adjusts a temperature of the corresponding heating piece 11 accordingly.

Referring to FIG. 2, in the first embodiment of the present disclosure, there are three heating pieces K1, K2, K3, and three temperature control switches that are a temperature control switch 1, a temperature control switch 2 and a temperature control switch 3. The temperature control switch 1 is configured to correspondingly turn on and turn off the heating piece K1 and control a temperature of the heating piece K1, the temperature control switch 2 is configured to correspondingly turn on and turn off the heating piece K2 and control a temperature of the heating piece K2, and temperature control switch 3 is configured to correspondingly turn on and turn off the heating piece K3 and control a temperature of the heating piece K3. The main control unit 21 is configured to scan an input interface that sends commands from the temperature control switch. For example, the main control unit 21 detects that the temperature control switch 2 inputs a control command, the main control unit 21 adjusts the heating piece K2 according to the control command. In this way, each of the plurality of heating pieces K1, K2, K3 can be individually controlled through its corresponding temperature control switch 22. As shown in FIGS. 3-4, if a user feels that a temperature of the heating piece K3 that is on his back zone is high, the user can individually lower the temperature of the heating piece K3 through the temperature control switch 3, while keeping the temperatures of the other heating pieces K1 and K2 unchanged. If the user feels that the temperature of the heating piece K2 that arranged on the abdomen zone is low, the user can individually raise the temperature of the heating piece K2 through the temperature control switch 2, while keeping the temperatures of the other heating pieces K1 and K3 unchanged, which allows the user to independently adjust the temperature according to their temperature needs for different zones; different temperatures can be set and respective gears can be freely adjusted. When the temperature requirements and sensitivity of different parts of the human body vary, the product of the present disclosure can be more suitable for practical usage to meet the needs of people with different temperatures.

Preferably, referring to FIG. 2, the power supply member 30 includes a battery 31 with a charge-discharge interface 32 thereof, and the charge-discharge interface 32 can be separate interfaces respectively for charging and discharging or an integrated interface for charging and discharging. The control member 20 further includes a power plug 26 and an electricity detection circuit 27. The power plug 26 is connected to the main control unit 21, and plug and unplug connected to the charge-discharge interface 32, and the electricity detection circuit 27 is connected to both the power plug 26 and the main control unit 21. The battery 31 receives an external power input through the charge-discharge interface 32. In the first embodiment, an external power source inputs a 5V DC power, and is connected to the power plug 26 through the charge-discharge interface 32 to supply power to the main control unit 21. As shown in FIG. 3, the battery 31 can connect to the external power source to be charged by a USB charging cable 40. The battery 31 is preferably a lithium battery. When using the multi-channel temperature control heating device 100, the power plug 26 is simply plugged to connect to the charge-discharge interface 32 of the battery 31. When the power plug 26 is connected to the charge-discharge interface 32 of the battery 31, the electricity detection circuit 27 is also connected to the battery 31 and detects a power of the battery 31. At the same time, the electricity detection circuit 27 sends a power signal of the battery 31 to the main control unit 21. The main control unit 21 selectively sends an alarm signal based on an amount of the power signal. If the power of the battery 31 is low at 20%, it will remind the user of insufficient power through flashing lights or voice prompts, to remind the user charge in a timely manner. In this way, when in the wild, the power alarm information can prompt users to return indoors for charging in a timely manner, thereby avoiding a loss of warmth and frostbite caused by the wearable heating product after the wearable heating product running out of power.

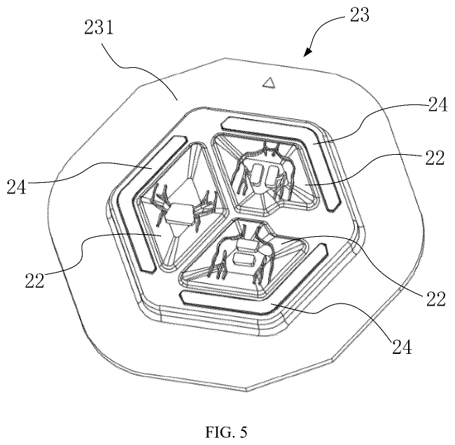

Referring to FIG. 5, the control member 20 includes a controller 23 that can be arranged on the wearable heating product 200, referring to FIG. 3, the controller 23 is installed on a lower right side of the front of the dress, and is exposed out of a surface of the dress. The controller 23 can be sewn and fixed onto the wearable heating product 200, or can be detachably installed on the wearable heating product 200 through buckles or other means. The controller 23 further includes a housing 231 configured to receive the main control unit 21 therein, the plurality of temperature control switches 22 arranged on the housing 231.

Referring to FIG. 5, in the first embodiment, the housing 231 of the controller 23 is a polygonal structure and configured to receive the main control unit 21 therein. Three temperature control switches 22 are arranged on an upper surface of the housing 231. The housing 231, the main control unit 21 and the three temperature control switches 22 are integrated together to form the controller 23.

Each temperature control switch 22 is equipped with a heating piece identification for the human body and different distribution positions, which can be easy to distinguish which area that the heating piece 11 is arranged on is controlled by each temperature control switch 22. For example, the temperature control switch 22 reflects through its identification that it controls the heating piece 11 that is arranged on the chest zone, the abdomen zone or the back zone.

The plurality of temperature control switches 22 of the first embodiment is integrated onto the controller 23, which is convenient to centralized control and adjustment of the plurality of heating pieces 11. At the same time, the main control unit 21 is also integrated onto the controller 23. During installation, the plurality of heating pieces 11 11 in different zones of the clothes only need to be connected through wires, and the power supply is also connected. It is easy to install the multi-channel temperature control heating device 100 and also facilitates the mass production of the controller 23, thereby reducing costs thereof.

Furthermore, referring to FIG. 2 and FIG. 5, the controller 23 further includes a plurality of gear status LED lamps 24 arranged on the housing 231 and respectively connected to the main control unit 21, each of the plurality of temperature control switches 22 having different temperature gears to adjust a corresponding heating piece to have different temperatures 11, each of the plurality of gear status LED lamps 24 associated with a corresponding temperature control switch 22, and each of the plurality of gear status LED lamps 24 configured to display different colors to correspond to different temperature gears of the corresponding temperature control switch 22. The temperature gear can be a certain temperature value or a temperature range value.

Referring to FIG. 5, the gear status LED lamp 24 is installed near each temperature control switch 22. If each temperature control switch 22 and its adjacent gear status LED lamp 24 are combined into a group of lamp and switch combination, in the first embodiment, there are three groups of lamp and switch combinations arranged on the controller 23, and each group of lamp and switch combination is interrelated. That is, when the user adjusts the gear of the temperature control switch 22 to control the heating piece 11 with different set temperatures, the group of the gear status LED lamp 24 displays different colors. In the first embodiment, in each group of lamp and switch combination, the gear status LED lamp 24 is bent into a line shape around edges of the switch.

Specifically, in the first embodiment of the present disclosure, each temperature control switch 22 has four temperature gears to control the corresponding heating piece 11 to have four different temperature ranges that are namely 55-60, 49-53, 43-47 and 37-40 degrees, so that the heating piece 11 that is controlled can reach four temperature ranges of 55-60, 49-53, 43-47 and 37-40 degrees. In the first embodiment, each gear status LED lamp 24 also has four different colors, such as red, yellow, green and blue, so as to be corresponding to the four temperature ranges of 55-60, 49-53, 43-47 and 37-40 degrees, respectively. When each temperature control switch 22 adjusts the temperature gear, the controller 23 can be turned on/turned off by pressing a duration of a button or by sequentially pressing the button within a unit time, for example, if the battery 31 is turned on and connected to the wearable heating product 200 through the power plug 26, the controller 23 will automatically be turned on and be corresponding to a temperature of 55-60 degrees, and then, pressing the temperature control switch 22 for 0.1 seconds to adjust to the temperature gear of 49-53 degrees; pressing the temperature control switch 22 again for 0.1 seconds to adjust to the temperature gear of 43-47 degrees; pressing the temperature control switch 22 once again for 0.1 seconds to adjust to the temperature gear of 37-40 degrees; pressing the temperature control switch 22 again for 0.1 seconds, then adjust to the temperature gear of 55-60 degrees, and repeating this process. Pressing the temperature control switch 22 for about 2 seconds to turn off the controller 23.

As an embodiment of the present disclosure, referring to FIG. 5, the upper temperature control switch 22 shown in FIG. 5 corresponds to the heating piece 11 that is arranged on the chest zone, the lower temperature control switch 22 corresponds to the heating piece 11 that is arranged on the back zone, and the left temperature control switch 22 corresponds to the heating piece 11 that is arranged on the abdominal zone. When the user presses the upper temperature control switch 22 shown in FIG. 5, the temperature of the heating piece 11 corresponding to the chest zone that is arranged on the wearable heating product 200 is adjusted accordingly. At the same time, the upper gear status LED lamp 24 shown in FIG. 5 displays the corresponding gear color. In this way, the controller 23 of the present disclosure can conveniently control the temperature of each heating piece 11, and can intuitively display the temperature gear corresponding to the temperature of each heating piece 11, thereby improving the user's experience.

The control member 20 further includes a plurality of temperature sensors 25, each of the plurality of temperature sensors 25 closely attached to a corresponding heating piece 11 and configured to collect temperature information of the corresponding heating piece 11 and then send to the main control unit 21. Referring to FIG. 2, there are three temperature sensors 25 in the embodiment, the temperature sensor 1 is closely attached to the heating piece K1 to collect the temperature of the heating piece K1, the temperature sensor 2 is closely attached to the heating piece K2 to collect the temperature of the heating piece K2, and the temperature sensor 3 is closely attached to the heating piece K3 to collect the temperature of the heating piece K3. The main control unit 21 adjusts a heating power of the corresponding heating piece 11 in a timely manner based on a temperature feedback from the temperature sensor 25, so that the temperature of the heating piece 11 reaches a preset temperature.

Specifically, referring to FIG. 2, the main control unit 21 further includes a master chip 211, a drive circuit 212 connected to the master chip 211, and a temperature signal processing circuit 213 connected to the master chip 211, wherein the drive circuit 212 is connected to the plurality of heating pieces 11, and the temperature signal processing circuit 213 is connected to the plurality of temperature sensors 25.

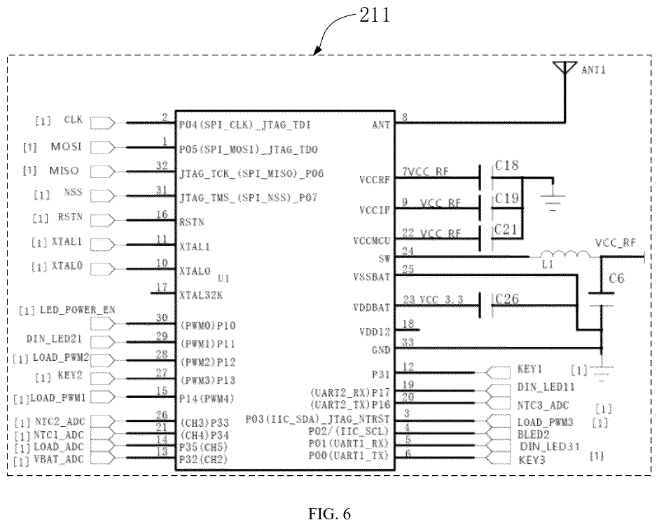

The master chip 211 is configured to control the entire circuit of the multi-channel temperature control heating device 100, and output PWM signals to control a heating temperature of each heating piece 11. The drive circuit 212 is configured to control the heating piece 11 to be turned on/turned off based on the PWM signals output by the master chip 211. The temperature signal processing circuit 213 is configured to filter and process signals that are input from the temperature sensor 25. Referring to FIG. 6, preferably, a model of the master chip 211 of the embodiment is BK3432.

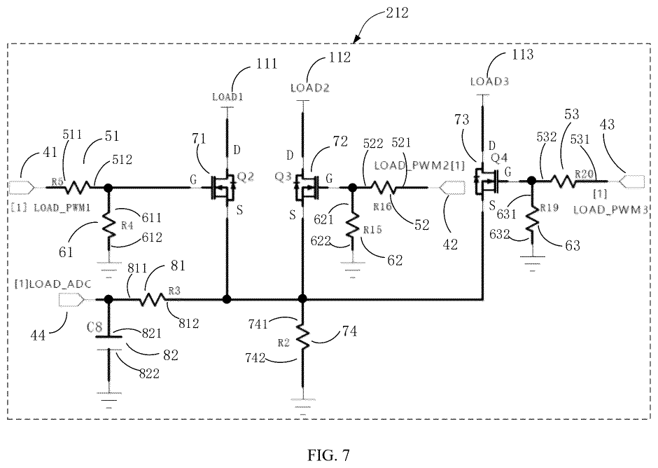

Specifically, referring to FIG. 7, the plurality of heating pieces 11 of the present disclosure at least includes a first heating piece 111, a second heating piece 112 and a third heating piece 113.

The master chip 211 is equipped with a first PWM output terminal 41, a second PWM output terminal 42, a third PWM output terminal 43 and a current sampling terminal 44.

The drive circuit 212 includes: a first current limiting resistor 51, a second current limiting resistor 52, a third current limiting resistor 53, a first bias resistor 61, a second bias resistor 62, a third bias resistor 63, a first MOS transistor 71, a second MOS transistor 72, a third MOS transistor 73 and a sampling resistor 74.

A first end 511 of the first current limiting resistor 51 is connected to the first PWM output terminal 41, and a second end 512 of the first current limiting resistor 51 is connected to a gate G of the first MOS transistor 71, a first end 611 of the first bias resistor 61 connected to the gate G of the first MOS transistor 71, a second end 612 of the first bias resistor 61 grounded, a drain D of the first MOS transistor 71 connected to the first heating piece 111, and a source S of the first MOS transistor 71 connected to a first end 741 of the sampling resistor 74.

A first end 521 of the second current limiting resistor 52 is connected to the second PWM output terminal 42, and a second end 522 of the second current limiting resistor 52 is connected to a gate G of the second MOS transistor 72, a first end 621 of the second bias resistor 62 connected to the gate G of the second MOS transistor 72, a second end 622 of the second bias resistor 62 grounded, a drain D of the second MOS transistor 72 connected to the second heating piece 112, and a source S of the second MOS transistor 72 connected to the first end 741 of the sampling resistor 74.

A first end 531 of the third current limiting resistor 53 is connected to the third PWM output terminal 43, and a second end 532 of the third current limiting resistor 53 is connected to a gate G of the third MOS transistor 73, a first end 631 of the third bias resistor 63 connected to the gate G of the third MOS transistor 73, a second end 632 of the third bias resistor 63 grounded, a drain D of the third MOS transistor 73 connected to the third heating piece 113, and a source S of the third MOS transistor 73 connected to the first end 741 of the sampling resistor 74.

A second end 742 of the sampling resistor 74 is grounded, and the first end 741 of the sampling resistor 74 is also connected to the current sampling terminal 44.

In the drive circuit 212, the first current limiting resistor 51, the second current limiting resistor 52 and the third current limiting resistor 53 respectively limit a current of the corresponding gate G of the first MOS transistor 71, the second MOS transistor 72 and the third MOS transistor 73. The first bias resistor 61, the second bias resistor 62 and the third bias resistor 63 provide stable bias voltages to the gates G of the first MOS transistor 71, the second MOS transistor 72 and the third MOS transistor 73, respectively, so as to ensure stable operation of the first MOS transistor 71, the second MOS transistor 72 and the third MOS transistor 73. The frequencies that turn on/turn off of the first MOS transistor 71, the second MOS transistor 72 and the third MOS transistor 73 are controlled by PWM signals output from the first PWM output terminal 41, the second PWM output terminal 42 and the third PWM output terminal 43 of the master chip 211, respectively, so as to control an output power of the drain D of each of the first MOS transistor 71, the second MOS transistor 72 and the third MOS transistor 73, thereby controlling the heating temperature of the first heating piece 111, the second heating piece 112 and the third heating piece 112, respectively. At the same time, the master chip 211 collects the current signal of the sampling resistor 74 through the current sampling terminal 44 to control the output power of the drains D of the first MOS transistor 71, the second MOS transistor 72 and the third MOS transistor 73.

Preferably, referring to FIG. 7, a first filtering resistor 81 is connected in series between the first end 741 of the sampling resistor 74 and the current sampling terminal 44, and a first filtering capacitor 82 is also connected in parallel between the first end 741 of the sampling resistor 74 and the current sampling terminal 44. The first filtering resistor 81 and the first filtering capacitor 82 form a filtering circuit configured to filter the sampling signal of the sampling resistor 74. Specifically, a first end 811 of the first filtering resistor 81 is connected to the current sampling terminal 44, and a second end 812 of the first filtering resistor 81 is connected to the first end 741 of the sampling resistor 74. The first end 821 of the first filtering capacitor 82 is connected to the current sampling terminal 44, and the second end 822 of the first filtering capacitor 82 is grounded.

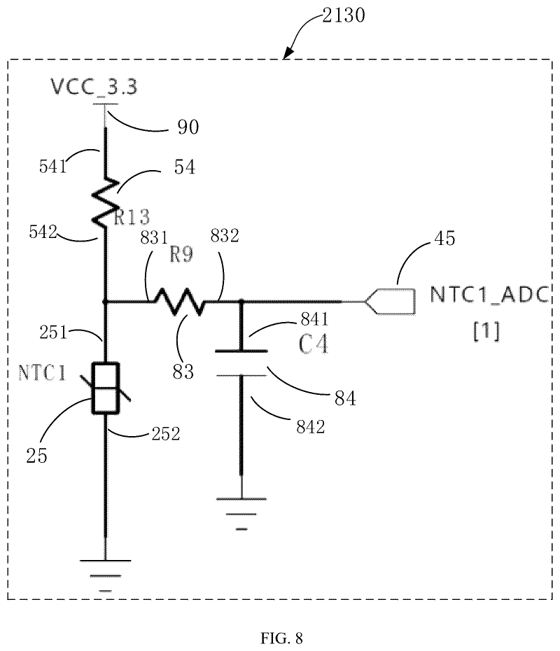

In the embodiment of the present disclosure, the master chip 211 is also equipped with a plurality of temperature detection terminals 45, and the temperature signal processing circuit 213 includes a plurality of temperature signal processing units 2130. Referring to FIG. 8, each of the plurality of temperature signal processing units 2130 is connected to a corresponding temperature detection terminal 45 and a corresponding temperature sensor 25, one of the plurality of temperature signal processing units 2130 including a fourth current limiting resistor 54, a second filtering resistor 83 and a second filtering capacitor 84.

A first end 541 of the fourth current limiting resistor 54 is connected to a power supply terminal 90, in the embodiment of the present disclosure, the power supply terminal 90 is powered by a DC VCC3.3V. A second end 542 of the fourth current limiting resistor 54 is connected to a first end 251 of a corresponding temperature sensor 25, and a second end 252 of the corresponding temperature sensor 25 is grounded, the first end 251 of the corresponding temperature sensor 25 also connected to a first end 831 of the second filtering resistor 83, a second end 832 of the second filtering resistor 83 connected to the temperature detection terminal 45, the second end 832 of the second filtering resistor 83 also connected to a first end 841 of the second filtering capacitor 84, and a second end 842 of the second filtering capacitor 84 grounded.

The second filtering resistor 83 and the second filtering capacitor 84 form a filtering circuit which filters the temperature signal sampled by the temperature sensor 251 and then inputs the temperature signal that has been filtered to the temperature detection terminal 45 of the master chip 211 for being processed, so as to ensure measurement accuracy of the temperature signal. A circuit that the temperature signal processing unit 2130 is correspondingly connected to the other temperature sensors 251 that is configured to collect information of the heating piece 11 in the present disclosure is basically the same as that is shown in FIG. 8, which will not be listed one by one here.

After the multi-channel temperature control heating device 100 of the embodiment is turned on, if it is not performed manual temperature adjustment thereon, each heating piece 11 enters a constant temperature control mode. If it enters the temperature range of 55-60 degrees, the temperature sensor 25 is placed on the heating piece 11 to collect temperature parameters of the heating piece 11, and then feeds back the temperature parameters that have been obtained to the temperature signal processing circuit 213. The temperature signal processing circuit 213 processes the temperature signal and then outputs it to the master chip 211; when the temperature reaches the preset temperature range, the master chip 211 controls the heating piece 11 to slowly heat or stop heating to slowly cool down; when the temperature is below the preset temperature range, the master chip 211 controls the heating piece 11 to start heating to keep a comfortable temperature for the human body.

The constant temperature control mode of the multi-channel temperature control heating device 100 of the embodiment is to maintain the temperature within a preset temperature range. Compared with the constant temperature control mode that is generally constant at a certain temperature point in the market, the constant temperature control mode with a constant range of the embodiment can keep the temperature within a comfortable temperature range that adapts to most people, thereby solving the problem that special adjustments are required due to differences in temperature and individual feelings during using the multi-channel temperature control heating device 100. When the constant temperature changes within the range of 55-60 degrees, users do not need to specifically adjust the temperature to 60 degrees, nor do they need to specifically adjust the temperature to 55 degrees. The temperature can automatically change within the range of 55-60 degrees to adapt to different body temperature perception requirements of the human body.

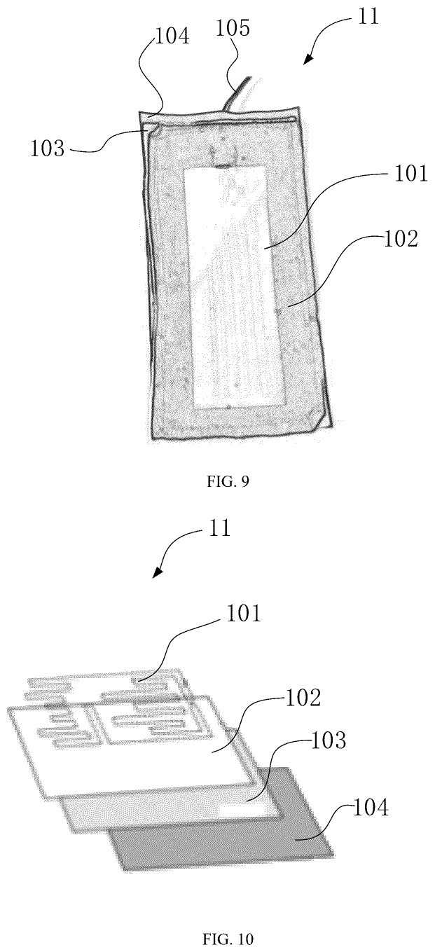

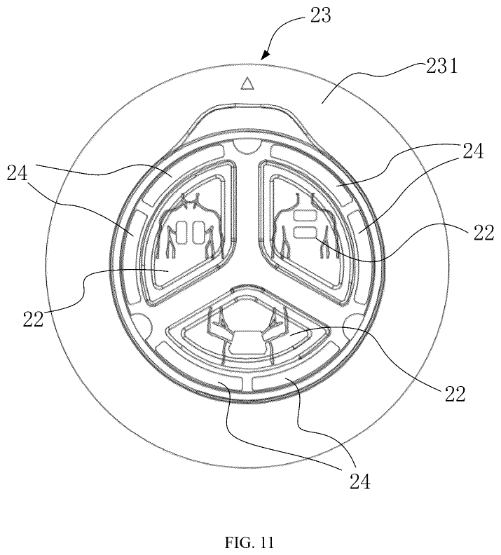

Specifically, referring to FIG. 9 and FIG. 10, each of the plurality of heating pieces 11 includes a heating body 101, an insulation layer 102, a heat preservation layer 103 and a heat-reflecting layer 104 that are sequentially layered in sequence, the heating body 101 connected to the main control unit 21, and all the heating body 101, the insulation layer 102, the heat preservation layer 103 and the heat-reflecting layer 104 are sewed together as a whole. The heating body 101 is connected to the drive circuit 212 of the main control unit 21 through wires 105. The heating body 101 is fixed to a side of the wearable heating product 200 that faces the human body, and is in contact with the human body. The heat-reflecting layer 104 is fixed to a side of the wearable heating product 200 that faces away from the human body to collect dissipated heat thereof.

In the embodiment of the present disclosure, the heating body 101 is a heating wire or a flexible and bendable heating film. Preferably, when the heating body 101 is a flexible and bendable heating film, the heating film is a PI (polyimide film) heating film that has a good heating effect and is easy to sew and fix on clothes.

Preferably, in the embodiment of the present disclosure, the heat-reflecting layer 104 is a metal reflection film that is a composite material composed of one or more layers of metal thin films, which is usually aluminum, chrome plated, or stainless steel. It can reflect thermal radiation and is easy to be produced.

In the embodiment of the present disclosure, the heating body 101, the insulation layer 102, the heat preservation layer 103 and the heat-reflecting layer 104 are generally fixed by sewing a fire-break. A heating thread is used in the heating piece 11 to be taken as the heating body 101, and the insulation layer 102 is an insulation material to effectively prevent heat from being transferred to the outside. At the same time, the insulation layer 102 is configured to fix the heating body 101. The heat preservation layer 103 can be made of an insulation cotton or other materials to prevent heat from being dissipated and play a heat insulation preservation role thereof, while the heat preservation layer 103 can fix the insulation layer 102; The heat-reflecting layer 104 can be made of an aluminum foil material to reflect heat back and further prevent heat from being flowed out. Because the heating piece 11 of the present disclosure provides the heat-reflecting layer 104, under the same heat generation conditions, the temperature of the warm area can increase by about 2 degrees, so that the heat generated by the heating piece 11 can be fully utilized.

In the embodiment of the present disclosure, the heating piece 11 can be directly sewn and fixed onto the wearable heating product 200 as a whole, or can be connected and fixed to the wearable heating product 200 through detachable methods such as Velcro.

Referring to FIG. 11, a multi-channel temperature controlled heating device 100 according to a second embodiment of the present disclosure is provided. A difference between the multi-channel temperature controlled heating device 100 of the second embodiment and the first embodiment lies in a shape of the controller 23 and a setting of the gear status LED lamp 24. In the second embodiment, the housing 231 of the controller 23 is circular. It can be understood that in other embodiments, the housing 231 of the controller 23 can also be other shapes. In the second embodiment, the gear status LED lamp 24 corresponding to each temperature control switch 22 is divided into two sections that are arranged thereon.

Other technical features of the second embodiment are the same as that of the first embodiment, therefore, the functions and effects of the multi-channel temperature control heating device 100 for the wearable heating product of the second embodiment are the same as that of the first embodiment, which will not be repeated here.

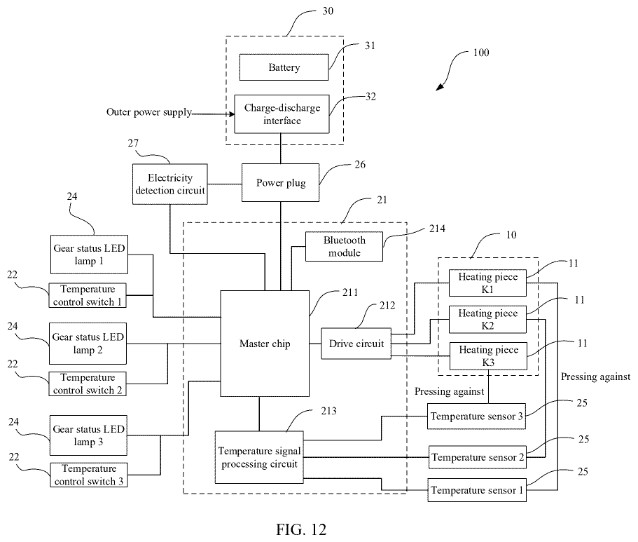

Referring to FIG. 12, a multi-channel temperature controlled heating device 100 according to a third embodiment of the present disclosure is provided. A difference between the multi-channel temperature controlled heating device 100 of the third embodiment and the first embodiment is: in the third embodiment, the main control unit 21 further includes a Bluetooth module 214 connected to the master chip or integrated with the master chip 211. The Bluetooth module 214 is configured to enables a smartphone to connect to the multi-channel temperature control heating device 100 through a Bluetooth to control the plurality of heating pieces 11 to be turned on/turned off and adjust temperatures of the plurality of heating pieces 11. That is, the Bluetooth module 214 is configured to enable a smartphone to connect to the multi-channel temperature control heating device 100 through an APP, so as to control the plurality of heating pieces 11 to be turned on/turned off and adjust temperatures of the plurality of heating pieces 11.

The Bluetooth module 214 of the third embodiment can be set separately from the master chip 211, or the Bluetooth module 214 of the third embodiment can be directly integrated with the master chip 211, such as the master chip of BK3432 with a Bluetooth module.

The multi-channel temperature control heating device 100 of the third embodiment can manually adjust the temperature, or wirelessly control the temperature of the heating piece 11 by a Bluetooth connection with a specially APP that is designed on the smartphone, thereby achieving diversity in temperature adjustment and control methods, and adapting to application scenarios of a modern intelligent life.

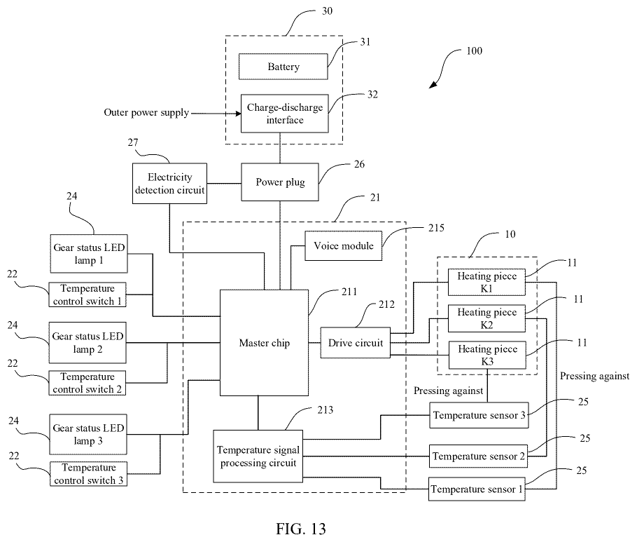

Referring to FIG. 13, a multi-channel temperature controlled heating device 100 according to a fourth embodiment of the present disclosure is provided. A difference between the multi-channel temperature controlled heating device 100 of the fourth embodiment and the first embodiment is: in the fourth embodiment, the main control unit 21 further includes a voice module 215 connected to the master chip 21 and configured to collect voice commands to control the plurality of heating pieces 11 to be turned on/turned off and adjust temperatures of the plurality of heating pieces 11. The voice module 215 is configured to collect voice commands and convert the voice commands into digital commands and then send the digital commands to the main control unit 21 for recognition. The main control unit 21 controls the temperature of the heating piece 11 based on the input voice commands. The multi-channel temperature control heating device 100 of the fourth embodiment can not only manually adjust the temperature of the heating piece 11, but also control the temperature of the heating piece 11 through the voice commands, thereby achieving diversity in temperature adjustment and control methods thereof.

It can be understood that in other embodiments of the present disclosure, the multi-channel temperature control heating device 100 for the wearable heating product can also adjust the temperature of the heating piece 11 through other ways, such as Remote Control through the Internet of Things.

The multi-channel temperature control heating device 100 for the wearable heating product of the present disclosure can implement manual temperature control, or a combination of Bluetooth APP temperature control and manual temperature control, or a combination of voice control temperature control and manual temperature control. Such temperature adjustment method is simple and easy to be operated. The temperature adjustment applied to clothes, trousers, belts, and even seat cushions is particularly convenient, and the multiple temperature control settings meet different temperature requirements of different parts of the human body.

The multi-channel temperature control heating device 100 of the present disclosure has manual temperature control and a constant temperature setting, and is equipped with a lithium battery and a USB cable externally. The battery can be used for a long time after being fully charged once. Before charging the battery, the charger is plugged into an AC socket at home and connect the battery to a plug of the charger to complete the connection therebetween. The temperature control switch is equipped with different temperature settings. It can manually adjust the temperature of the heating piece 11, and the control member is controlled by a special program and a chip, which has three temperature control modes. A button of the temperature control switch 22 that arranged on the clothes is pressed every time, the main control unit 21 of the control member 20 receives a signal, compares and processes the signal to inform the drive circuit 212, and outputs proportionally to achieve different temperature levels. Or set a constant temperature, the temperature sensor 25 is placed on the heating piece 11, and combined with the temperature signal processing circuit 213, to make the temperature of the heating piece 11 reach the set temperature, in order to maintain human comfort.

A wearable heating product 200 according to an embodiment of the present disclosure is equipped with the above-mentioned multi-channel temperature control heating device 100 that is used for the wearable heating product 200.

In the present disclosure, the wearable heating product 200 can be selected from one kind of a dress, a trouser, a hat, a belt and a scarf, and can include other products such as heating cushions.

Specifically, referring to FIG. 3 and FIG. 4, the wearable heating product 200 is a dress, the dress is equipped with at least three heating zones 201, and the multi-channel temperature control heating device 100 is equipped with at least six heating pieces 11 and three temperature control switches 22, one of the at least three heating zones 201 equipped with two of the at least six heating pieces 11, and one of the thee temperature control switches 22 configured to simultaneously control temperatures of the two heating pieces 11. That is, in the embodiment, each heating zone 201 of the thermal insulation dress is equipped with two heating pieces 11 to enhance the heating and insulation effect of each heating zone 201.

Although the features and elements of the present disclosure are described as embodiments in particular combinations, each feature or element can be used alone or in other various combinations within the principles of the present disclosure to the full extent indicated by the broad general meaning of the terms in which the appended claims are expressed. Any variation or replacement made by one of ordinary skill in the related art without departing from the spirit of the present disclosure shall fall within the protection scope of the present disclosure.

What is claimed is:

1. A multi-channel temperature control heating device for a wearable heating product, the heating device comprising:
a heating member comprising a plurality of heating pieces respectively set in different areas of the wearable heating product; and
a control member comprising a main control unit connected to the plurality of heating pieces, and a plurality of temperature control switches connected to the main control unit, each of the plurality of temperature control switches configured to independently control a temperature of one of the plurality of heating pieces.

2. The heating device as claimed in claim 1, wherein the control member comprises a controller arranged on the wearable heating product and comprising a housing configured to receive the main control unit therein, the plurality of temperature control switches arranged on the housing.

3. The heating device as claimed in claim 2, wherein the controller further comprises a plurality of gear status LED lamps arranged on the housing and respectively connected to the main control unit, each of the plurality of temperature control switches having different temperature gears to adjust a corresponding heating piece to have different temperatures, each of the plurality of gear status LED lamps associated with a corresponding temperature control switch, and each of the plurality of gear status LED lamps configured to display different colors to correspond to different temperature gears of the corresponding temperature control switch.

4. The heating device as claimed in claim 1, wherein the control member further comprises a plurality of temperature sensors, each of the plurality of temperature sensors closely attached to a corresponding heating piece and configured to collect temperature information of the corresponding heating piece and then send to the main control unit.

5. The heating device as claimed in claim 4, wherein the main control unit further comprises a master chip, a drive circuit connected to the master chip, and a temperature signal processing circuit connected to the master chip, wherein
the drive circuit is connected to the plurality of heating pieces, and the temperature signal processing circuit is connected to the plurality of temperature sensors.

6. The heating device as claimed in claim 5, wherein the plurality of heating pieces at least comprises a first heating piece, a second heating piece and a third heating piece; and wherein
the master chip is equipped with a first PWM output terminal, a second PWM output terminal, a third PWM output terminal and a current sampling terminal; and wherein the drive circuit comprises:
a first current limiting resistor, a second current limiting resistor and a third current limiting resistor;
a first bias resistor, a second bias resistor and a third bias resistor;
a first MOS transistor, a second MOS transistor, a third MOS transistor and a sampling resistor; and wherein
a first end of the first current limiting resistor is connected to the first PWM output terminal, and a second end of the first current limiting resistor is connected to a gate of the first MOS transistor, a first end of the first bias resistor connected to the gate of the first MOS transistor, a second end of the first bias resistor grounded, a drain of the first MOS transistor connected to the first heating piece, and a source of the first MOS transistor connected to a first end of the sampling resistor; and wherein
a first end of the second current limiting resistor is connected to the second PWM output terminal, and a second end of the second current limiting resistor is connected to a gate of the second MOS transistor, a first end of the second bias resistor connected to the gate of the second MOS transistor, a second end of the second bias resistor grounded, a drain of the second MOS transistor connected to the second heating piece, and a source of the second MOS transistor connected to the first end of the sampling resistor; and wherein
a first end of the third current limiting resistor is connected to the third PWM output terminal, and a second end of the third current limiting resistor is connected to a gate of the third MOS transistor, a first end of the third bias resistor connected to the gate of the third MOS transistor, a second end of the third bias resistor grounded, a drain of the third MOS transistor connected to the third heating piece, and a source of the third MOS transistor connected to the first end of the sampling resistor; and wherein
a second end of the sampling resistor is grounded, and the first end of the sampling resistor is also connected to the current sampling terminal.

7. The heating device as claimed in claim 6, wherein a first filtering resistor is connected in series between the first end of the sampling resistor and the current sampling terminal, and a first filtering capacitor is also connected in parallel between the first end of the sampling resistor and the current sampling terminal.

8. The heating device as claimed in claim 5, wherein the master chip is also equipped with a plurality of temperature detection terminals, and the temperature signal processing circuit comprises a plurality of temperature signal processing units, each of the plurality of temperature signal processing units connected to a corresponding temperature detection terminal and a corresponding temperature sensor, one of the plurality of temperature signal processing units comprising a fourth current limiting resistor, a second filtering resistor and a second filtering capacitor; and wherein
a first end of the fourth current limiting resistor is connected to a power supply terminal, a second end of the fourth current limiting resistor is connected to a first end of a corresponding temperature sensor, and a second end of the corresponding temperature sensor is grounded, the first end of the corresponding temperature sensor also connected to a first end of the second filtering resistor, a second end of the second filtering resistor connected to the temperature detection terminal, and the second end of the second filtering resistor also connected to a first end of the second filtering capacitor, and a second end of the second filtering capacitor grounded.

9. The heating device as claimed in claim 1, wherein the main control unit further comprises a Bluetooth module connected to the master chip or integrated with the master chip, the Bluetooth module configured to enable a smartphone to connect to the multi-channel temperature control heating device through an APP, so as to control the plurality of heating pieces to be turned on/turned off and adjust temperatures of the plurality of heating pieces.

10. The heating device as claimed in claim 1, wherein the main control unit further comprises a voice module connected to the master chip and configured to collect voice commands to control the plurality of heating pieces to be turned on/turned off and adjust temperatures of the plurality of heating pieces.

11. The heating device as claimed in claim 1, wherein each of the plurality of heating pieces comprises a heating body, an insulation layer, a heat preservation layer and a heat-reflecting layer that are sequentially layered in sequence, the heating body connected to the main control unit, and all the heating body, the insulation layer, the heat preservation layer and the heat-reflecting layer sewed together as a whole.

12. The heating device as claimed in claim 11, wherein the heating body is a heating wire or a flexible and bendable heating film.

13. The heating device as claimed in claim 12, wherein the heating film is a PI (polyimide film) heating film.

14. The heating device as claimed in claim 11, wherein the heat-reflecting layer is a metal reflection film.

15. The heating device as claimed in claim 1, wherein the multi-channel temperature control heating device further comprises a power supply member comprising a battery with a charge-discharge interface thereof, and the control member further comprises a power plug and an electricity detection circuit, wherein
the power plug is connected to the main control unit, and plug and unplug connected to the charge-discharge interface, and the electricity detection circuit is connected to both the power plug and the main control unit.

16. A wearable heating product equipped with a multi-channel temperature control heating device used for the wearable heating product.

17. The wearable heating product as claimed in claim 16, wherein the wearable heating product is selected from one kind of a dress, a trouser, a hat, a belt and a scarf.

18. The wearable heating product as claimed in claim 17, wherein when the wearable heating product is a dress, the dress is equipped with at least three heating zones, and the multi-channel temperature control heating device is equipped with at least six heating pieces and three temperature control switches, one of the at least three heating zones equipped with two heating pieces, and one of the thee temperature control switches configured to simultaneously control temperatures of the two heating pieces.
